(19) United States
(12) Patent Application Publication
(10) Pub. No.: US 2013/0009743 A1
(43) Pub. Date: Jan. 10, 2013

(54) CIRCUIT BREAKER

(75) Inventors: Bernhard RÖSCH, Sulzbach-Rosenberg (DE); Yi Zhu, Darmstadt (DE)

(73) Assignee: SIEMENS AKTIENGESELLSCHAFT, Munich (DE)

(21) Appl. No.: 13/540,949

(22) Filed: Jul. 3, 2012

(30) Foreign Application Priority Data
Jul. 5, 2011 (EP) 11172629.5

(51) Int. Cl. H01H 37/52

(52) U.S. Cl. 337/3

(57) ABSTRACT

A circuit breaker includes a short-circuit release and a thermal overload release. In at least one embodiment, the short-circuit release includes an armature and a pole which are disposed within a coil former, as well as a yoke plate and a terminal connection which are disposed around the coil former. The thermal overload release includes a metal strip made of at least two types of metal, around which a PTC thermistor is wound, wherein an electric insulator is disposed between PTC thermistor and metal strip. In at least one embodiment, the connection between the thermal overload release and the yoke plate is made by way of a separate bracket.

PRIORITY STATEMENT

The present application hereby claims priority under 35 U.S.C. §119 to European patent application number EP 11172629.5 filed Jul. 5, 2011, the entire contents of which are hereby incorporated herein by reference.

### FIELD

At least one embodiment of the invention generally relates to a circuit breaker with a short-circuit release and a thermal overload release, wherein the short-circuit release has an armature and a pole which are disposed within a coil former, as well as a yoke plate and a terminal connection which are disposed around the coil former, and wherein the thermal overload release has a metal strip comprising at least two types of metal, around which a PTC thermistor is wound, wherein an electrical insulator is disposed between PTC thermistor and metal strip.

### BACKGROUND

Circuit breakers with short-circuit releases are used for switching and protection of motors and other loads. These short-circuit releases are designed as electromagnetic releases, which essentially include a coil winding, a coil former, an armature, a pole, a plunger, a restraining spring and a yoke. The armature pulls in at a specific circuit breaker rated current, for example at twelve times the rated current for motor protection or at nineteen times the rated current for transformer protection. The armature movement in the process acts on a switch mechanism and on a moving switching piece, in order to open the contacts. Standards dictate that the response current may only fluctuate by a maximum of +/−20%.

For greater adjustment ranges it is difficult to position the coil winding accurately because of the larger supporting cross-sections required, the smaller numbers of turns, the wider tolerances for the coil and the winding wire and the more inhomogeneous magnetic field associated with this, with respect to the air gap between the armature and the pole in order to make it possible to comply with the response limits in accordance with Standards. Furthermore, there is a problem in fixing the coil winding in the position with respect to the air gap once this has been determined, so that the coil winding is not moved in the direction of the center of gravity of the iron at the rated current or in the event of high short-circuit current, or with the coil being compressed or deformed as a consequence, often resulting in it no longer complying with the response limits.

For higher switching ratings the coils are manufactured with close-fitting winding turns in order to prevent the coil being able to compress and deform with higher switching ratings. Because uniform coil formers are used for the respective size of coil and its layout for the geometrically largest coil winding, a gap frequently arises between coil former flange and the last turn of the coil winding. After the precise positioning of the coil winding in relation to the air gap between armature and yoke, for fixing the coil winding, the one turn end is glued to the coil former flange or yoke and the other winding end is welded to the terminal.

For circuit breakers with a high switching capability, for example up to 100 kA at a rated current of 80 A, the short-circuit release must be adapted. The high switching capability of an 80 A device means that management of heating is critical. In addition, on account of the increasing contact load, the force demand on the trigger also increases. Under the precondition that the release may not have more power loss than current 50 A releases with the corresponding same excitation, the magnetic circuit must be constructed in a more efficient manner.

The magnetic circuit is worse in today's switching devices since the yoke plate is simultaneously embodied as a bimetal strip support and is made from a platinized material from a pairing of iron and copper.

Previously this problem of a worse magnetic circuit was resolved by way of a platinized copper-steel sheet and corresponding arrangement of the parts. Furthermore partly joined materials can be manufactured and subsequently arranged shaped for the desired material pairing. Likewise other shapes of yoke plate are used which surround the core of the release, consisting of armature and pole, in order to interact with the coil and achieve a release action. The level of force of these releases is maintained by a high-dimensioned excitation. This means an inefficient energy conversion between electrical and mechanical energy.

### SUMMARY

A circuit breaker is provided with a short-circuit release and a thermal overload release which, at high switching ratings, exhibit a defined release behavior with an optimized thermal stress.

Advantageous embodiments and developments, which can be used individually or in combination with one another, are the subject matter of the dependent claims.

A circuit breaker is disclosed in at least one embodiment with a short-circuit release and a thermal overload release, wherein the short-circuit release has an armature and a pole which are disposed within a coil former, and also a yoke plate and a terminal connection which are disposed around the coil former, and wherein the thermal overload release has a metal strip comprising at least two types of metal around which the PTC thermistor is wound, wherein an electrical insulator is disposed between PTC thermistor and metal strip. In at least one embodiment, the thermal overload release is attached to the yoke plate by way of a separate bracket.

### BRIEF DESCRIPTION OF THE DRAWINGS

Further advantages and embodiments of the invention are explained below on the basis of exemplary embodiments with reference to the drawing, in which the schematic figures show:

FIG. 1 a perspective diagram of an example embodiment of an inventive connection between a thermal overload release and a yoke plate of a circuit breaker via a separate bracket;

FIG. 2 a perspective diagram of the example embodiment according to FIG. 1, viewed from behind;

FIG. 3 a perspective diagram of an example embodiment of a separate bracket with embossing and stamped sections on the yoke plate for positioning;

FIG. 4 a perspective diagram of an example embodiment of the separate bracket with embossing and pins on the yoke plate for positioning;

FIG. 5 a perspective diagram of an example embodiment of the separate bracket with embossing and a pocket for receiving and connecting the thermal overload release;

FIG. 6 a perspective diagram of the example embodiment according to FIG. 5 rotated through 90°;

FIG. 7 a perspective diagram of the further example embodiment of a separate bracket with material extension.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EXAMPLE EMBODIMENTS

The present invention will be further described in detail in conjunction with the accompanying drawings and embodiments. It should be understood that the particular embodiments described herein are only used to illustrate the present invention but not to limit the present invention.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

A circuit breaker is disclosed in at least one embodiment with a short-circuit release and a thermal overload release, wherein the short-circuit release has an armature and a pole which are disposed within a coil former, and also a yoke plate and a terminal connection which are disposed around the coil former, and wherein the thermal overload release has a metal strip comprising at least two types of metal around which the PTC thermistor is wound, wherein an electrical insulator is disposed between PTC thermistor and metal strip. In at least one embodiment, the thermal overload release is attached to the yoke plate by way of a separate bracket.

The inventive attachment, in at least one embodiment, of the thermal overload release to the yoke plate by a separate bracket is preferably undertaken with a rigid bracket. This includes the fixed connection between the separate bracket, especially a steel bracket, and the yoke plate. The rigid embodiment can preferably be achieved by a steel bracket which has an embossed area for stiffening. In addition it is possible to make the connection between the thermal overload release, i.e. between the metal strip, which is preferably embodied from bimetal, and the separate bracket by a welded connection which is disposed offset in height.

In an especially advantageous embodiment the joining of the steel bracket to the yoke plate is undertaken by stop lugs or pins.

It is also conceivable to join the steel bracket to the yoke plate without stop lugs or pins or to manufacture the steel bracket without embossing or beading. This means that a new assessment of the designs in respect of the tolerances, the torque, the materials and also the deflection behavior is necessary.

In accordance with at least one embodiment of the invention there is also provision for the fixing to be undertaken using a correspondingly adapted mold nest. This mold nest can also be used as a weld receptacle in order to connect the two parts. The connection between the thermal overload release, i.e. between the bimetal strip and the separate bracket, can be made by laser welding for example, in which one or more longitudinal seams are realized which are disposed vertically in respect of one another. The connection can also be made with another welding method, for example resistive welding or a tungsten inert gas welding. It is also conceivable to solder the connection or to use screws.

It is especially advantageous to use the separate bracket in an upright form, since a more rigid overall system is produced in this way. The thermal release is embodied more rigidly overall. There is also advantageously provision for the height of the separate bracket to be able to be varied in order in this way to take account of the greater continuous stress. In an especially advantageous embodiment there is provision for the direct connection between the separate bracket and the bimetal strip to be implemented by a pocket in the separate bracket in order to guarantee precise positioning. After the positioning the parts are joined together. In a further operating step the coil is combined with the bimetal strip. This too can be implemented by known welding methods. In particular there is provision for an adapted shape of the coil between coil end and bimetal strip to lead to parallel alignment, which simplifies the connection of the two parts.

The circuit breaker of at least one embodiment is characterized by the thermal overload release, i.e. the bimetal strip, is attached to the yoke plate of the short-circuit release by way of an additional part in the form of the separate bracket. The separate bracket, especially a steel bracket, can be fixed to the yoke plate via punched-out stops or pins in the yoke plate. The choice of methods for connecting includes laser welding, tungsten inert gas welding, soldering, resistive welding or screws. The rigid connection between the separate bracket and the yoke can on the one hand the achieved by an embossed section in the separate bracket, on the other hand by means of a height-offset welding of the bimetal strip to the bracket. All in all this leads to a stiffening of the overall system of the release. It is also advantageous that the separate bracket serves as a fixed positioning for the connection of the winding coil of the short-circuit release. In addition the separate bracket can serve, by virtue of the individual shape, as a height stop and fixing for the overall system of the circuit breaker module into an adapted upper part or into a chamber respectively. Further advantages of the inventive circuit breaker are that the separate bracket can be used as bulk goods and saves materials so that a cost saving is produced overall.

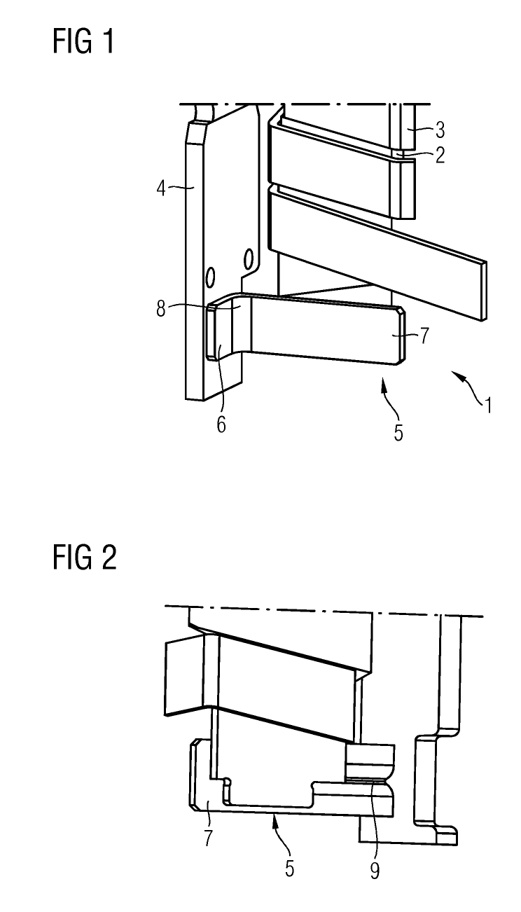

FIG. 1 shows an example embodiment of an inventive connection between a thermal overload release 1 having a metal strip 2 consisting of at least two types of metals and a PTC thermistor 3 which is wound around the metal strip 2, and a yoke plate 4 of the short-circuit release of a circuit breaker. In an embodiment, the inventive connection between the metal strip 2, preferably a bimetal strip, and the yoke plate yoke plate 4, is embodied as an additional part in the form of a separate bracket 5. The separate packet 5 is preferably embodied in the shape of a letter L with two arms 6, 7, which are connected to one another via a bent area 8. The arms 6, 7 can preferably have different lengths. The arm 6 of the separate bracket 5 is connected over its surface to the yoke plate 4, for example by a welded connection or by soldering. Likewise the arm 7 of the separate bracket 5 is connected via parts of its surfaces to the metal strip 2 of the thermal release 1. The arms 6, 7 are preferably at an angle of 90° to one another.

FIG. 2 shows the example embodiment according to FIG. 1 in a view from behind. A cutout is embodied in the arm 7 in the material 9 of the separate bracket 5 which is disposed centrally and runs along the arm 7.

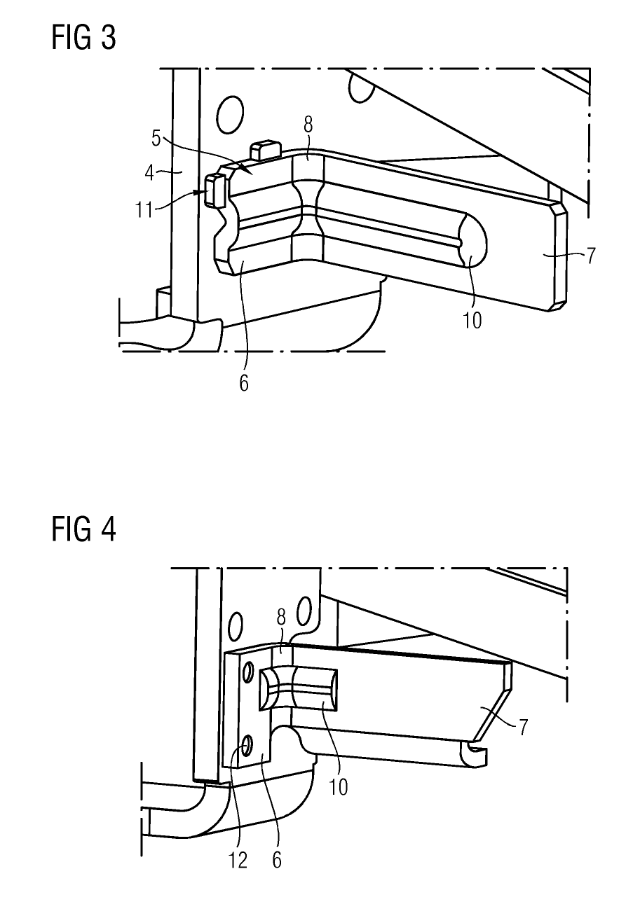

FIG. 3 shows an example embodiment of a separate bracket 5, which has an embossed section 10 and is positioned via stops 11 on the yoke plate 4. The embossed section 10 is embodied over the entire arm 6, the bent area 8 and over part of the arm 7. The embossed section 10 serves to stiffen the overall system of thermal overload release and short-circuit release.

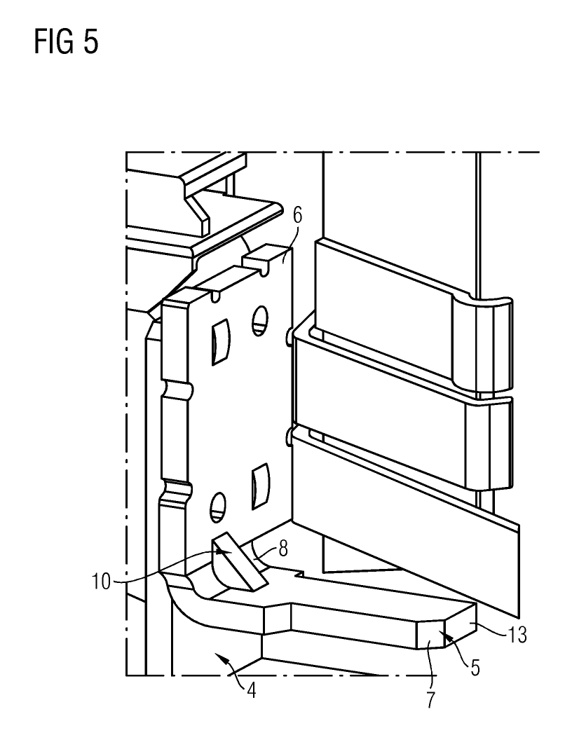

FIG. 4 shows a further example embodiment of a separate bracket 5 with embossed section 10, wherein the embossed section 10 is only embodied here over part of the arm 6, 7 as well as in the bent area 8. Pins 12 are embodied on the yoke plate 4 for positioning which engage in recesses in the separate bracket 5.

FIG. 5 shows a further example embodiment of the separate bracket 5 with embossed area 10, wherein the embossed area 10 is only embodied here in the bent area 8 of the L-shaped separate bracket 5. In addition the separate bracket 5 has a pocket on arm 7 in the form of a recess 13 which serves to accommodate and connect the thermal overload release 1. In addition the arm 6 of the separate bracket 5 is disposed in this example embodiment upright on the yoke plate 4 and thus offset by 90° in relation to the example embodiments from FIG. 1 through 4. The result of this is that the connection to the thermal overload release 1 is not established via the surface of the arm 7 of the separate bracket 5, but via the recess 12 which is made in the arm 7.

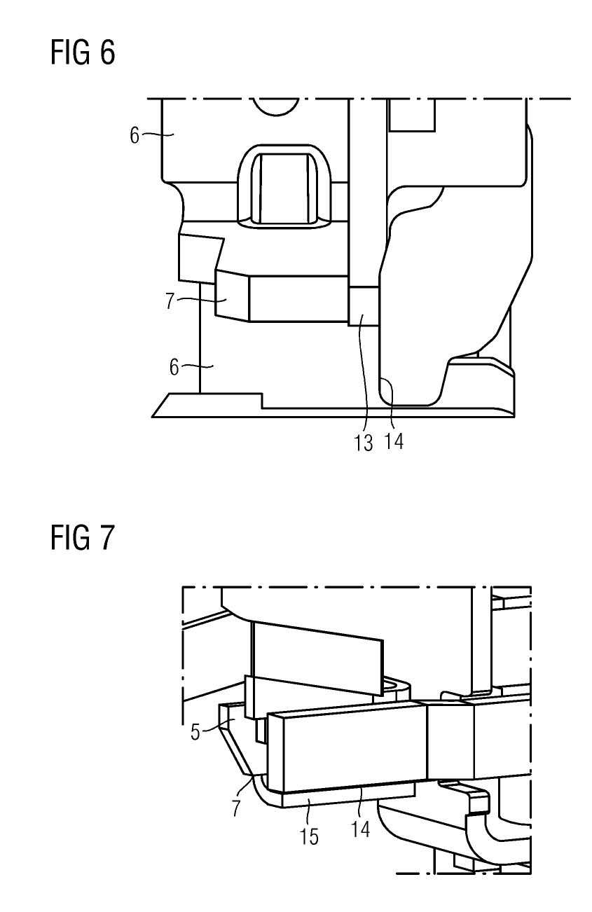

FIG. 6 shows the example embodiment according to FIG. 5 in a diagram rotated through 90°. This shows the arrangement between the arm 7 of the separate bracket 5, the thermal overload release in the form of its metal strip 2 and the coil extension 14 of an adjoining short-circuit release. FIG. 6 shows the recess 13 for the metal strip 2 in a front view. FIG. 6 also reveals the parallel arrangement of arm 7 of the separate bracket 5, metal strip 2 and coil extension 14.

FIG. 7 shows a further example embodiment of an inventive separate bracket 5, wherein here a preferably bent material extension 15 is embodied on the lower side edge of the arm 7, which serves as a support surface for the coil extension 14.

The inventive circuit breaker of at least one embodiment is characterized in that the thermal overload release, i.e. the bimetal strip, is attached to the yoke plate of the short-circuit release by way of additional part in the form of a separate bracket. The separate bracket, especially a steel bracket, can be fixed to the yoke plate via punched-out stops or pins in the yoke plate. The choice of connection technique can be laser welding, tungsten inert gas welding, soldering, resistive welding, screws or rivets. The rigid connection between the separate bracket and the yoke plate can be achieved on the one hand by an embossed section in the separate bracket, on the other hand by means of a height-offset welding of the bimetal strip. Overall this leads to a stiffening of the entire release system. It is also of advantage for the separate bracket to serve as a fixed positioning for the use of the coil of the short-circuit release.

In addition the separate bracket can serve through its individual shape as a height stop and fixing for the overall system of the circuit breaker module in an adapted upper section or in a chamber respectively. Further advantages of the inventive circuit breaker are the fact that the separate bracket can used as bulk material and saves material, so that overall a cost saving is produced.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims.

Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A circuit breaker comprising:
a short-circuit release including
an armature and a pole, disposed within a coil former, and
a yoke plate and a terminal connection, disposed around the coil former;
a thermal overload release including
a metal strip made of at least two types of metal, around which a PTC thermistor is wound, an electrical insulator being disposed between PTC thermistor and metal strip; and
a separate bracket to connect the thermal overload release and the yoke plate.

2. The circuit breaker of claim 1, wherein a connection between the yoke plate and the separate bracket and a connection between the separate bracket and the thermal overload release are welded connections.

3. The circuit breaker of claim 2, wherein the weld is a laser weld, tungsten inert gas weld or resistive weld.

4. The circuit breaker of claim 1, wherein a connection between the yoke plate and the separate bracket a connection between the separate bracket and the thermal overload release are soldered.

5. The circuit breaker of claim 1, wherein the separate bracket is positioned on the yoke plate via stops.

6. The circuit breaker of claim 1, wherein the separate bracket is positioned on the yoke plate via pins.

7. The circuit breaker of claim 1, wherein the separate bracket includes an embossed section for stiffening the circuit breaker comprising short-circuit release and thermal overload release.

8. The circuit breaker of claim 1, wherein the separate bracket includes a recess.

9. The circuit breaker of claim 2, wherein the separate bracket is positioned on the yoke plate via stops.

10. The circuit breaker of claim 2, wherein the separate bracket is positioned on the yoke plate via pins.

11. The circuit breaker of claim 3, wherein the separate bracket is positioned on the yoke plate via stops.

12. The circuit breaker of claim 3, wherein the separate bracket is positioned on the yoke plate via pins.

13. The circuit breaker of claim 4, wherein the separate bracket is positioned on the yoke plate via stops.

14. The circuit breaker of claim 4, wherein the separate bracket is positioned on the yoke plate via pins.
